(19) United States
(12) Patent Application Publication
(10) Pub. No.: US 2010/0287148 A1
(43) Pub. Date: Nov. 11, 2010

(54) Method, System, and Apparatus for Targeted Searching of Multi-Sectional Documents within an Electronic Document Collection

(75) Inventors: Jason David Resnick, Clifton, VA (US); Randy W. Lacasse, Fairfax Station, VA (US)

Correspondence Address: COMPUTER PATENT ANNUITIES NORTH AMERICA, LLC;C/O CPA GLOBAL, P.O. BOX 52050, MINNEAPOLIS, MN, 55402, US

(73) Assignee: CPA GLOBAL PATENT RESEARCH LIMITED

(21) Appl. No.: 12/644,709

(22) Filed: Dec. 22, 2009

Related U.S. Application Data
(63) Continuation of application No. PCT/US09/43371, filed on May 8, 2009.

(51) Int. Cl. G06F 17/30

(52) U.S. Cl. 707/706; 707/736; 707/754; 707/E17.008; 707/E17.014

(57) ABSTRACT

A method, system, and article are provided for efficiently and effectively searching an electronic document collection. Each of the documents in the collection is pre-divided into sub-sections, and a static document vector is created for one or a combination of each sub-section of each document. A dynamic document vector is created for a query string submitted to the document collection. Based upon the parameters of the query, select sub-sections of each document are employed in a comparison of the dynamic document vector with select static document vectors. A compilation of IP documents is created based upon all associated select static document vectors that fall within a range of the dynamic document vector.

### STATEMENT OF PRIORITY

This is a continuation of International Application PCT/US09/43371, with an international filing date of May 8, 2009.

### BACKGROUND OF THE INVENTION

1. Technical Field

This invention relates to an electronic document collection, and searching the collection in response to receipt of a query. More specifically, the invention relates to categorizing multiple sections of each document, and efficiently processing the query responsive to the categorized sections of the documents in the collection.

2. Description of the Prior Art

All intellectual property documents, including patent, trademark, and copyright application must be submitted for registration or examination before a government agency assigned to receive such application. Patent applications submitted for examination before a government patent office must meet certain requirements, including, each patent must be deemed new, useful, and non-obvious. Similar standards are applied in patent offices of most, if not all, foreign patent offices. To properly prepare a patent application for examination, it is useful to have knowledge of prior patents, i.e. prior art, in related areas of technology as only one patent may be granted per invention. The process of ascertaining prior art is known as a patent search. The results of the patent search generally help the drafter of any subsequent patent application focus their efforts on what appears to be patentable subject matter and aids in developing a reasonable strategy for achieving the goals of the inventor or owner of the patent rights.

Prior to the evolution of technology into the current electronic information age, it was known that patent searches were conducted manually. A searcher would review a patent disclosure and based upon a patent classification system, ascertain where the patent disclosure may be classified, and thereafter conduct a search. With the advent of information technology, paper searching is no longer available as all patents and published patent applications are only available in electronic form. Even with the electronic format of the patent document, similar strategies employed with the hand search can be used for searching an electronic patent database.

Different classes of searches may be commissioned to achieve different results. For example, a novelty search may be commissioned for ascertaining whether or not to file for a patent. A product clearance search may be commissioned for ascertaining whether a product is covered under the claims of a current patent. An invalidity search may be commissioned to determine if the issued claims of a patent are valid, etc. Prior electronic search tools do not support the different classes of searches. Rather, the burden is on the person doing the search, also known as the searcher, to limit the sections of a patent document to be reviewed in the search based upon the scope of the search. As the quantity of patents and published patent applications in the database grow, the burden on the searches increase as more patents and published patent applications need to be reviewed for each search.

Accordingly, there is a need for a tool for use by a searcher to mitigate the burdens associated with the search and related search scope. The tool should enable the searcher to leverage the different sections of a patent document during the search to more efficiently and effectively yield accurate and desirable search results.

### SUMMARY OF THE INVENTION

This invention comprises a method, system, and article for efficiently and effectively searching a collection of intellectual property documents, such as patent documents.

In one aspect of the invention, a computer method is provided for searching an electronic document collection. A collection of intellectual property documents is compiled, with each of the intellectual property documents in the collection being comprised of multiple sections. For example, at the time of indexing the collection, at least one document vector is derived for each patent document in the collection. The derivation of the document vector includes creation of at least one static document vector for each document in the collection. At the time of submission of a query to the collection, a dynamic document vector is created based upon the string submitted with the query input. Submission of the query input to the collection results in a comparison of the dynamic document vector associated with the query input with each static document vector in the collection. A compilation of relevant patent documents are returned based upon a comparison of the dynamic document vector with the static document vectors of the collection.

In another aspect of the invention, a computer system is provided with a processor in communication with storage media, and an electronic document collection maintained on the storage media. The electronic document collection is a compilation of patent or other intellectual property documents. Based upon characteristics of patent documents, each of the patent documents in the collection has multiple sections. At indexing time, at least one document vector is derived for each patent document in the collection. The creation of the document vector includes creation of at least one static document vector for each patent document in the document collection. At query time, a dynamic document vector is created from string data received from a query input. Following the creation of the dynamic document vector, the query input is submitted to the electronic patent document collection. A query manager in communication with the input manager compares the dynamic document vector to each static document vector in the collection in response to submission of the query input to the patent document collection. Following the submission by the query manager, a compilation of relevant patent documents is returned with the compilation based upon the comparison of the dynamic with the static document vectors.

In yet another aspect of the invention, an article is provided with a computer-readable carrier including computer program instructions configured to search an electronic document collection on computer memory. The computer-readable carrier includes computer program instructions to perform over the document collection. Instructions are provided to compile a collection of patent documents. Each of the patent documents in the collection is divided into multiple sections. At the time of indexing the collection, instructions are provided to derive at least one document vector for each patent document in the collection. This includes creation of at least one static document vector for each patent document in the document collection. At the time of submission of a query to the collection, instructions are provided to create a dynamic document vector based on string data from a query input. Following creation of the dynamic document vector, the query is submitted to the electronic document collection for comparison of the dynamic document vector with each static document vector in the collection. Results of the query submission include a compilation of relevant patent documents returned based upon comparison of the dynamic with the static document vectors in the collection.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a flow chart illustrating searching an electronic document collection, and more specifically a collection pertaining to patents and patent publications;

FIG. 2 is a flow chart illustrating a general process for submission of a query to the patent document collection;

FIG. 3 is a flow chart illustrating a process for employing stop words to further parse static document vectors in a patent document collection;

FIG. 4 is a flow chart illustrating a process for creating multiple document vectors for each patent document in the collection;

FIG. 5 is a flow chart illustrating a process for submission of a query to the document collection with multiple document vectors therein, according to the preferred embodiment of this invention, and is suggested for printing on the first page of the issued patent;

FIG. 6 is a block diagram illustrating a set of tools employed to process a query submitted to the electronic document collection; and

FIG. 7. is a block diagram of a graphical user interface for user input designations to search the electronic document collection.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers. A manager may be implemented in programmable hardware devices such as field programmable gate arrays, programmable array logic, programmable logic devices, or the like. The manager may also be implemented in software for execution by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of document managers, input managers, query managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### OVERVIEW

Static and dynamic document vectors are employed with an intellectual property document. Hereinafter, the discussion will be particular to a patent document. In one embodiment, the application of the document vectors may be applied to any intellectual property document. A document vector is a set of (keyword, weight) pairs, where the keyword is a word or phrase associated with an underlying document, and the weight is a numerical measure of how important the keyword is for the documents. More specifically, document vectors are a type of document signature that represents the document content in a manner that facilitates comparison between documents. It is the numerical representation of the unstructured textual content of the document. The static document vectors are associated with patents and published patent applications as these documents are not subject to frequent changes. The dynamic document vector is associated with a query string data, hereinafter strings, submitted to the patent document collection. The static document vectors may be parsed to exclude strings that are specific to patents and have minimal value in conducting a search. The excluded strings are referred to as stop words. In one embodiment, the stop words employed herein is specific to the patent community. In addition, each patent document has defined sections therein, with each section identifying different portions of a patent document. When conducting a patent search, there are different values placed on the different sections of the patent document. As such, depending upon the scope of the patent search, the search may be limited to specific sections of the patent documents. Accordingly, document vectors are employed in a patent document collection to efficiently and effectively create a result set with data pertinent to the query submitted to the collection, wherein the result set is one or more documents in the patent document collection whose static document vector(s) are calculated to be within a set mathematical range of the dynamic document vector associated with the submitted query string data.

### TECHNICAL DETAILS

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

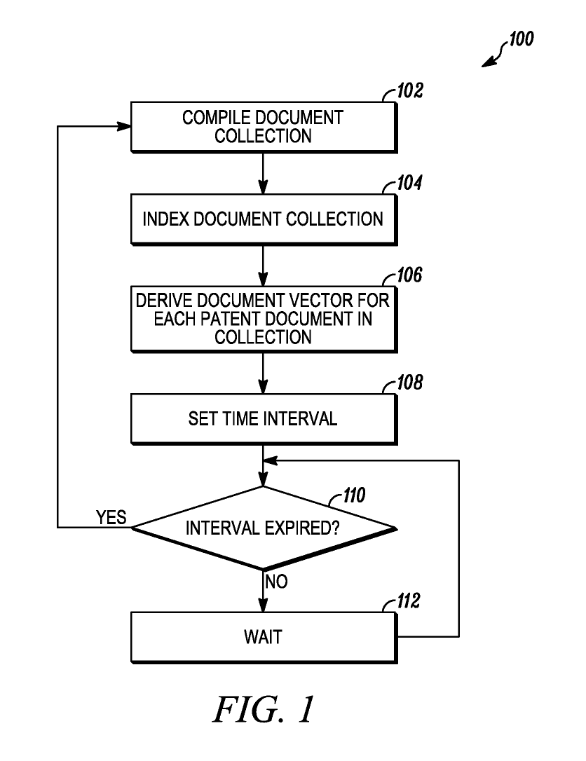

FIG. 1 is a flow chart (100) illustrating a general view of searching an electronic document collection, and more specifically a collection pertaining to patents and patent publications. Initially, a collection of patent documents is compiled (102). It is recognized in the art that patents and patent publications are comprised of multiple sections. Following the compilation of the documents, the collection is indexed (104). The process of indexing the compilation includes converting a collection of data into a database suitable for search and retrieval. More specifically, indexing the document collection includes deriving a document vector for each patent document in the collection (106). A document vector comprises a weighted list of words and phrases. In one embodiment, terms to be selected into the document vector include, but are not limited, noun phrases, words in title case but not at the beginning of a sentence, and words which occur frequently in the document. Weights are computed for the terms placed into the vector. In one embodiment, the following methods for computing the weights may include, but are not limited to, the frequency of the word in the document normalized to a number from one to zero, where one is assigned to the word which occurs most frequently in the document, boosting words or word-pairs in selected fields of the document, assigning a higher weight to noun phrases, elevating title case words in the body of the document, and assigning a higher weight to longer strings over shorter strings. Once the words and phrases for inclusion in the document vector have been selected and the weights for the words and phrases have been selected, the document vector is computed through employment of an integrator. In one embodiment, the integrator can select which fields to include in the vector and how much to boost the words and phrases which they contain, select how much each of the factors contributes to the final term weight, add entity types into the vectors, such as elevating the significance of a corporate entity found in the document, and increasing a stop word list to remove common phrases found in the database. Document vectors created for each patent document in the collection are termed “static document vectors.”

Other than a few exceptions, once a patent document issues, it is generally not subject to change. The exceptions to this rule include, but are not limited to, issuance of a certificate of correction, a re-examination of an issued patent, and a re-issue of an issued patent. To address these exceptions, the document collection is updated. More specifically, a time interval is established for updating any changes to the documents in the collection, and the associated document vectors (108). Examples of the time interval include, but are not limited to, monthly, semi-annually, annually, etc. Thereafter, it is determined if the established time interval has expired (110). A positive response to the determination at step (110) is followed by a return to step (102). Conversely, a negative response to the determination at step (110) is following by waiting a set time period to update the patent document vector to incorporate any changes to the patent documents into the document vectors (112), followed by a return to step (110). In one embodiment, the patent collection is not limited to granted patents, and includes published patent applications. Accordingly, based upon the inherent nature of patents, a patent document collection should be updated on a periodic basis to address any changes to any of the patents in the collection.

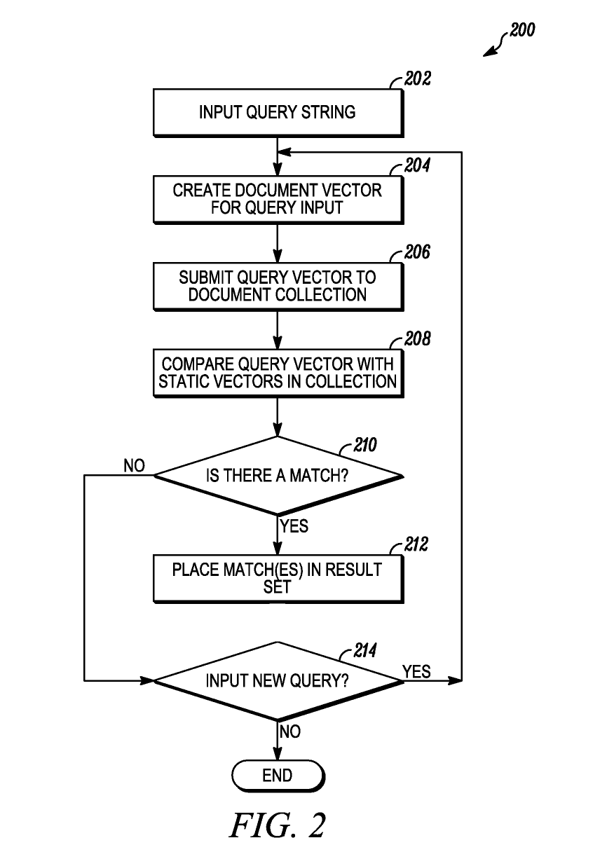

Once the document collection has been parsed to create static document vectors for the collection, a query may be performed over the collection. FIG. 2 is a flow chart (200) illustrating a general process for submission of a query to the patent document collection. Initially, an input query is received (202). In one embodiment, the input query is comprised of a string. A document vector is created for the query input (204). Since the document vector for the query is created at the time of submission, it is hereinafter referred to as a dynamic document vector. The dynamic document vector is created based on the text input for the query. More specifically, the dynamic document vector consists of the most relevant terms from the query input text. There are different tools that may be employed to select the string(s) for inclusion in the dynamic document vector and to assign weights to the terms selected for inclusion in the vector. In one embodiment, the following strings are extracted from the input query: noun phrases, words which are in title case, i.e. first letter capitalized but not at the beginning of a sentence, words which occur frequently in the document, pairs of words which occur frequently in the document. As in the static document vectors, designated stop words are removed and not included in the dynamic document vector. Once the terms for inclusion in the dynamic vector are extracted from the text of the input query, weights are assigned to these terms. In one embodiment, the frequency of each term or phrase in the document is normalized to a number from 1 to 0, where 1 is assigned to the word which occurs most frequently in the document. Similarly, in one embodiment, words or word-pairs in special fields, such as the title, are boosted, noun phrases are assigned a higher weight, title case words in the body of the document are boosted, longer strings are assigned a higher weight over shorter strings, etc. Computing the document vector is highly configurable. In one embodiment, a user can assign a weight to search terms. Accordingly, there are various tools that may be invoked to create an appropriate dynamic document vector based upon the query input.

Following step (204), the query in the form of the dynamic document vector is submitted to the document collection (206), where the dynamic document vector is compared to the static document vectors in the patent document collection (208). It is then determined whether any of the static document vectors in the collection are within a defined mathematical range of the dynamic document vector (210). A positive response to the determination at step (210) is followed by placing all of the underlying patent documents in the collection with one or more static document vectors that fall within the defined mathematical range in a result set (212). Either following step (212) or in response to a negative response to the determination at step (210), it is determined if the user would like to submit a new query to the document collection (214). In one embodiment, the new query may narrow the scope of the previously submitted query. Similarly, the new query may enlarge the scope of the previously submitted query. Regardless of the scope of the new query, a positive response to the determination at step (214) is followed by a return to step (204). Similarly, a negative response to the determination at step (214) marks an end to the query submission process to the document collection. Accordingly, submission of a query to the document collection includes conversion of a submitted string to a dynamic document vector, and comparison of the document vector with the static vectors of the document collection.

A patent document collection is a unique collection of technical documents. Patent documents come in the form of issued patent grants and published patent applications. The difference between the two categories of documents identifies their enforceable value. More specifically, a patent grant is an actual property right that can be enforced in a court of law, whereas a published patent application is a pending application that is a pending patent right. Each patent document that is written contains words and phrases that are customary for placement in the application. However, such words and phrases have minimal value in searching, as these words and phrases appears in most patent documents and are not unique to the invention therein. Examples of such words and phrases include, but are not limited to “embodiment”, “exemplary”, “prior art”, etc. Similarly, each country may have different words that are commonplace in patent applications. For example, in some countries the word “characterized” is a common word with little patentable or search value. Such words are referred to herein as stop words. The purpose of identifying stop words specific to a country, language, and or culture, is to minimize the size of the document vectors to be search. Each document vector in the patent document collection may be parsed to remove identified stop words from the collection.

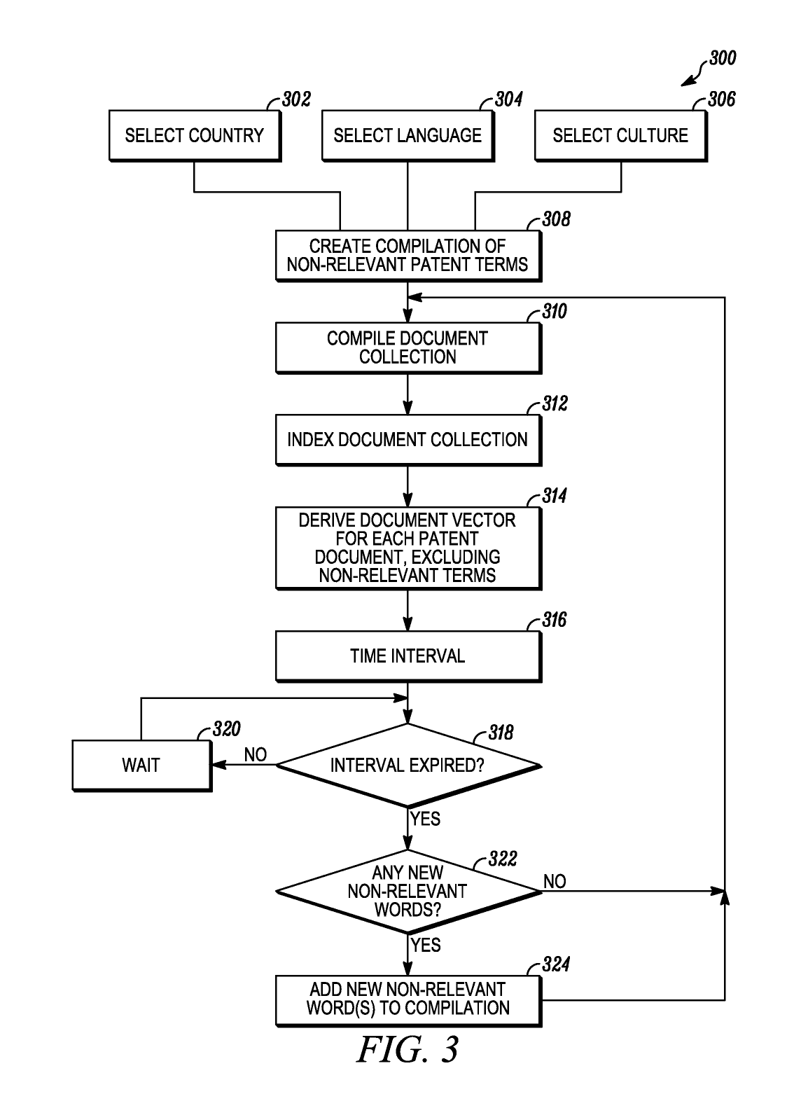

FIG. 3 is a flow chart (300) illustrating a process for employing stop words to further parse static document vectors in a patent document collection. Prior to submission of a query to the document collection, it is determined if the static document vectors should be parsed for stop words. The stop words may be limited to a specific country (302), a specific language (304), and/or a specific culture (306). A positive response to any individual selection or combination of selections at steps (302), (304), and/or (306) is followed by creation of a compilation of stop words for parsing the static document vectors in the patent document collection (308). A collection of patent documents is compiled (310). In one embodiment, the collection of patent documents may be limited to the selected country, language, and/or specific culture. Following the compilation of the documents (310), the collection is indexed (312) and the stop words are parsed from the collection (314). The process of indexing and removing stop words from the compilation includes converting a collection of data into a database suitable for search and retrieval. Following step (314), one or more sections of the documents in the collection are selected to be included in the document vectors to be created for the collection (316). Based on the selection of at least one section at step (316), a document vector is created for each patent document in the collection (318). More specifically, following indexing of the document collection, a document vector is derived for the selected sections of each patent document in the collection with omission of identified stop words from the derived document vectors. Such document vectors are referred to herein as static document vectors.

Other than a few exceptions, once a patent document issues it is generally not subject to change. To address these exceptions, the document collection is infrequently updated. More specifically, a time interval (320) is established for updating any changes to the documents in the collection, and the associated document vectors. Examples of the time interval include, but are not limited to monthly, semi-annually, annually, etc. Thereafter, it is determined if the established time interval has expired (322). A negative response to the determination at step (322) is followed by waiting a set time period (324) to update the patent document vectors to incorporate any changes to the patent documents into the document vectors, followed by a return to step (320). Whereas, a positive response to the determination at step (322) is followed by a determination as to whether there are any new stop words to be applied to the document collection (326). A negative response to the determination at step (326) is followed by a return to step (310), and a positive response to the determination at step (326) is followed by adding the new stop word(s) and/or phrase(s) to the compilation of non-relevant patent terms (328). Following step (328), the process of creating and/or updating static document vectors for a patent document collection returns to step (310). Accordingly, the static document vectors may be parsed for a selection of identified stop words to enable submission of a query to focus on relevant strings in the static document collection.

It is recognized that issued patents and published patent applications are divided into multiple sections. Each section of the patent document is required for a submission of a completed patent application, and each section of a patent has a purpose. The details of each section of a patent application are not going to be discussed in detail herein. However, the different sections will be identified. For the most part, each patent application includes a title, a priority filing date, an abstract, a background description, a summary, a brief description of the drawing figures (if any), a detailed description of the invention, and claims. There are different search categories that are employed in the patent arena depending upon the purpose of the search. For example, an infringement and/or product clearance search is concerned with the words in the claims, and therefore should be directed to the claims present in the document collection. A validity and/or invalidity search is concerned with any known prior art, and requires identification of the priority filing date of the patent document. When an inventor(s) seeks to determine the novelty of their invention prior to or following submission of a patent application, the inventors or his/her agent or representative may commission a novelty search. Such a search may de-emphasize the claims and focus on the detailed description of the invention. Accordingly, as shown herein, each search places emphasis on different sections of a patent document in the document collection.

As demonstrated above, each patent in the document collection may be parsed for a selection of stop words that have minimal value in a search of the collection. However, in addition to or separate from the selection of stop words, it may be desirable to compile a plurality of static document vectors for a single patent document, with each separate document vector pertaining to each identified section of the patent document in the collection. The creation of multiple document vectors, with each vector identifying a specific section, enables a search of the document collection to be refined based upon a defined scope of the search. As an example, an infringement search in the document collection may be limited to document vectors pertaining to the claims section of each patent in the document collection.

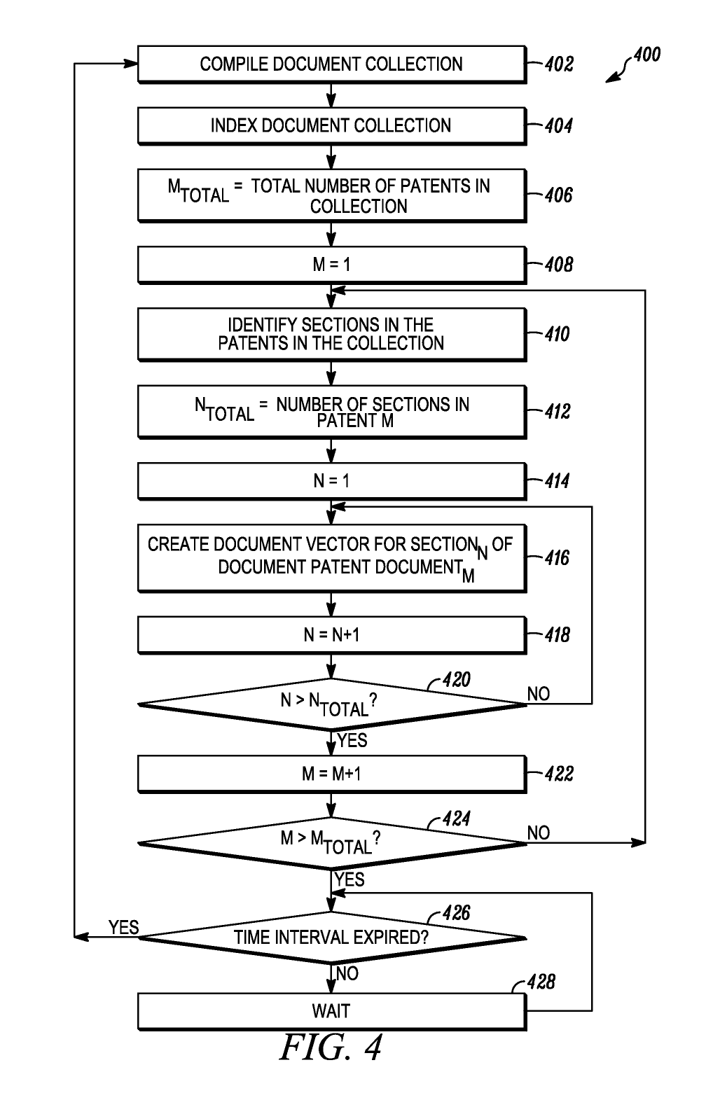

FIG. 4 is a flow chart (400) illustrating a process for creating multiple document vectors for each patent document in the collection. Initially, the collection of patent documents is compiled (402) and indexed (404). The variable M_{Total} is assigned to the total number of documents in the patent document collection (406), and the counting variable M is assigned to the integer one (408). The quantity of sections in patent documents M in the collection is identified (410). Following step (410), the variable N_{Total} is assigned to the total number of sections in patent document M (412), and the counting variable N is assigned to the integer one (414). A document vector is created for each section of each patent document in the collection. More specifically, a document vector is created for each Section_{N} of PatentDocument_{M} (416). Once the document vector at step (416) is created, the counting variable N is incremented (418) to proceed to the next section of the patent document for creation of the next document vector for the next section, if there is another section of the patent document. Following step (418), a determination is conducted as to whether there are any more sections in the patent document for creation of a document vector (420). A negative response to the determination at step (420) is followed by a return to step (416). Conversely, a positive response to the determination at step (420) is followed by an increment of the variable M (422). It is then determined if each document in the collection has been parsed for creation of multiple document vectors (424). A negative response to the determination at step (424) is followed by a return to step (410) for creation of multiple document vectors for the next document in the collection. As explained above, it is known in the art that the static document collection may need to be updated on a periodic basis. The frequency of the update may be frequent or infrequent depending upon the accuracy of the collection. In one embodiment, the frequency of updating the static document vectors may be proportional to the issuance rate of patents. A positive response to the determination at step (424) is an indication that the patent document collection has been parsed to create multiple document vectors for each patent document. It is then determined if the time interval for updating the static vectors in the collection has expired (426). A positive response to the determination at step (426) is followed by a return to step (402). Conversely, a negative response to the determination at step (426) is followed by waiting for a set time interval to update the patent document vector in order to incorporate any changes to the patent documents into the document vectors (428) prior to returning to step (426). Accordingly, each patent document in the document collection may be parsed to create multiple static document vectors with each vector pertaining to one identified section of the patent document.

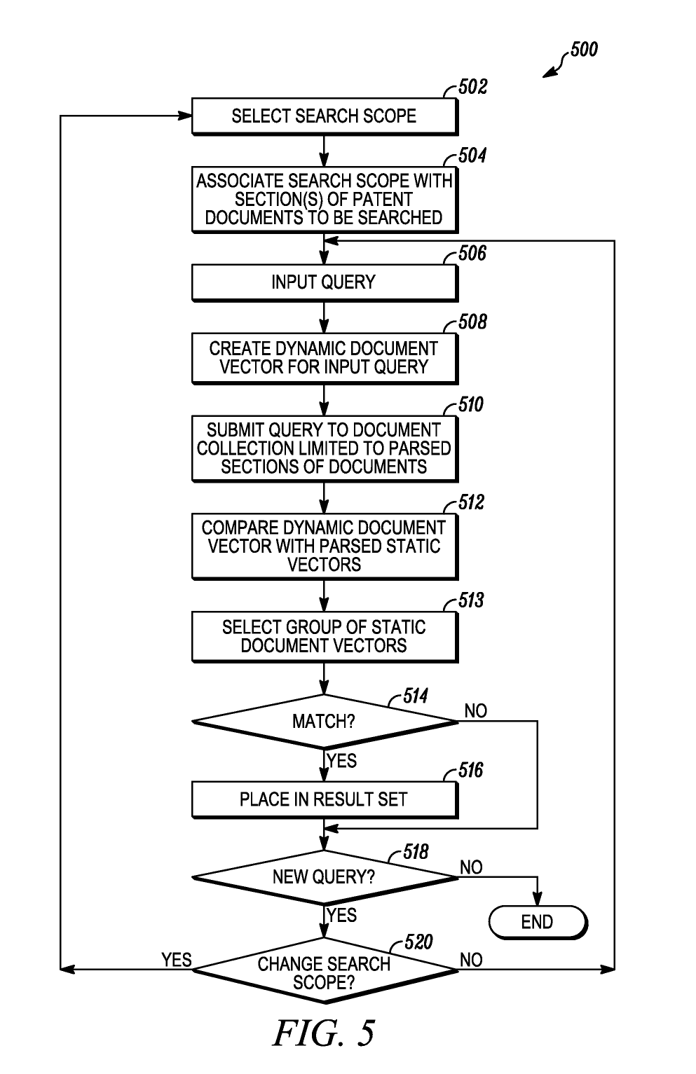

Once the patent documents have been parsed to create multiple document vectors for each document in the collection, submission of the query may leverage the parsing of the document sections. FIG. 5 is a flow chart (500) illustrating a process for submission of a query to the document collection with multiple document vectors therein. Initially, a user submitting a query to the collection defines the scope of the search (502). In one embodiment, the user may be provided with a graphical user interface as a layer over computer instructions to facilitate selection of the scope of the search. Following step (502), the defined scope of the search is associated with a selection of document vector categories for the document collection (504), and a query string is submitted to the document collection (506). Thereafter, a dynamic document vector is created for the submitted query string (508), and the dynamic document vector is submitted to the document collection to determine relevant documents (510). The query submission is limited to a comparison of the dynamic document vector with select static document vectors of the document collection (512). In one embodiment, the selection of static document vectors may be the selection of a group of static document vectors (513). More specifically, a search that is limited to the claims section of a patent document will only search the static document vectors, or the group of like static document vectors, of the claims section of the patents in the patent document collection. The comparison at step (512) is a mathematical comparison of the dynamic document vector with the static document vectors. A result set of the comparison is sorted based upon the mathematical comparison (514). In one embodiment, the sorting is hierarchical based upon the closeness of the static document vector(s) of the document collection to the dynamic document vector. Accordingly, a comparison of the dynamic document vector with the static document vectors of the collection generates a result set.

Once the result set has been sorted (514), a mathematical value is employed to define the range of closeness of the sorted documents determined to be relevant (516). Following step (516), it is determined if there are any documents in the sorted collection that fall within the defined mathematical range (518). A positive response to the determination at step (518) is followed by placing a list of all of the underlying patents within a static document vector within the defined range of the dynamic document vector in a result set (520). Following step (520) or a negative response to the comparison at step (518), it is determined if the user wants to submit a new query string or further limit the query of the prior query string submission (522). A negative response to the determination step (522) signals an end to the query submission process. Conversely, a positive response to the determination at step (522) is followed by a subsequent determination as to whether the user would like to change the sections, i.e. static document vectors, of the search to be compared to the query (524), i.e. dynamic document vector. In one embodiment, altering the scope of the search may directly change the selection of static document vectors employed in the search. A positive response to the determination at step (524) is followed by a return to step (502) as the new query will change the sections of the patent document to be evaluated in the next query. Conversely, a negative response to the determination at step (524) is an indication that the new query will further limit the scope of the prior query while maintaining the limitation of the same document vectors in the patent collection as in the prior query. As such, a negative response is following by submission of the further modification of the query and not the document vectors of the patent document collection, and a return to step (506). Accordingly, the scope of the search may be altered in two aspects to modify the result set based upon the comparison of the dynamic document vector of the query with the static document vectors of the patent document collection.

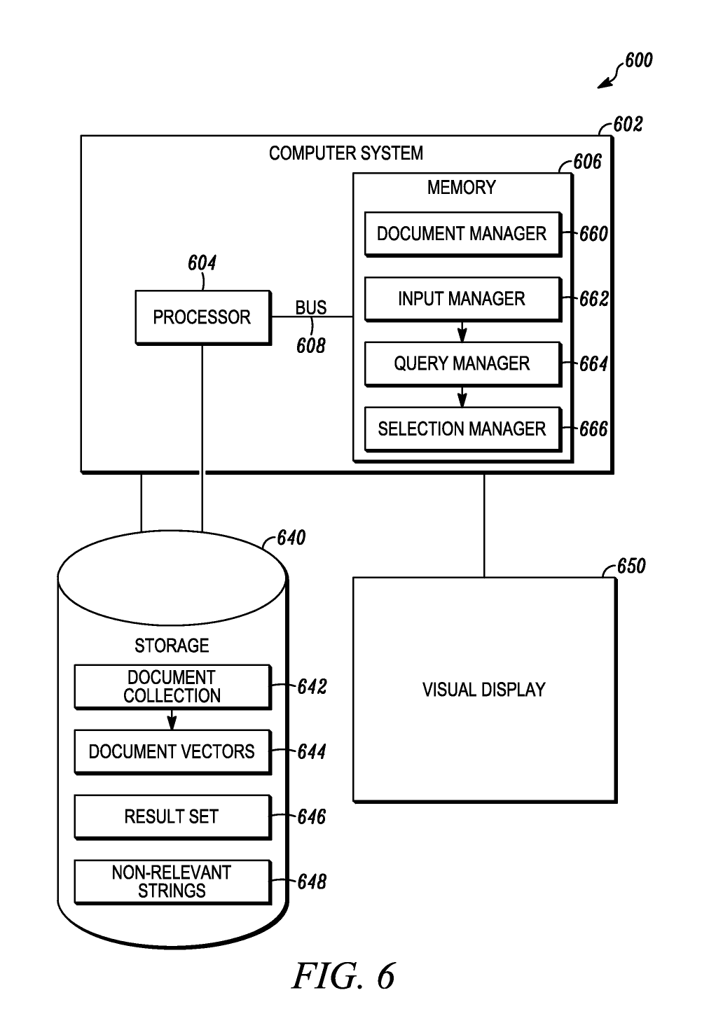

As shown in FIGS. 1-5, document vectors are created specific to a patent document collection, and then employed for query submission to create a result set within a dynamic document vector that falls within a defined range of the static document vectors of the collection. FIG. 6 is a block diagram (600) illustrating a set of tools for creating the static and dynamic document vectors and for employing the vectors in association with a query submitted to the document collection. As shown, a computer system (602) is provided with a processor unit (604) coupled to memory (606) by a bus structure (608). Although only one processor unit (604) is shown, in one embodiment, more processor units may be provided in an expanded design. The system (602) is shown in communication with storage media (640) configured to house a document collection (642). In one embodiment, the electronic document collection includes a compilation of patent documents, including issued patents and published patent applications. The storage media (640) is in communication with the processor unit (604). In addition, the system is shown in communication with a visual display (650) for presentation of visual data. Each of the elements shown and described herein support query submission to the document collection (642).

A document manager (660) is provided local to the computer system (602) and in communication with memory (606). The document manager (660) is responsible for deriving a document vector for each patent document in the collection (642) at the time of indexing. More specifically, the document manager (660) creates at least one static document vector (644) for each patent document in the collection (642). As explained above, each patent document is comprised of specific standardized sections, which may also be uniform if issued from the same patent office jurisdiction. In one embodiment, the document manager (660) is employed to create multiple static document vectors (644) for each patent document. The document vectors (644) created by the document manager (660) are housed in the storage media (640). An input manager (662) is also provided local to the computer system (602) and in communication with memory (606). The input manager (662) is responsible for creating a dynamic document vector at query time based on string data received from a query input. The input manager (662) is in communication with a query manager (664), also provided local to the computer system (602) and in communication with memory (606). The query manager (664) is responsible for the comparison of the dynamic document vector, created by the input manager (662), with each static document vector (644) in response to submission of a query input to the document collection (642). The comparison yields a compilation of relevant patent documents (646). In one embodiment, the compilation is presented on the visual display (650). Similarly, in one embodiment, the compilation may be retained on storage, either volatile or persistent.

A compilation of non-relevant string data (648) may be employed to parse non-relevant string data from the static document vectors (644). In one embodiment, the compilation of non-relevant string data (648) is retained on storage media (640) and periodically updated by the document manager (660). Either employing or disregarding the non-relevant string data, the document manager (660) may be directed to create multiple static document vectors for each patent document in the document collection (642). A selection manager (666) is provided local to the computer system (602) and in communication with memory (606). More specifically, the selection manager (666) is in communication with the query manager (664) to select a search scope to the document collection. The selected search scope determines a selection of static document vectors to be applied by the query manager (664) to process the query.

In one embodiment, the input manager (662), query manager (664), document manager (660), and selection manager (666), may reside in memory (606) local to the computer system (602). However, the invention should not be limited to this embodiment. For example, in one embodiment, the input, query, document, and selection managers (660)-(666) may each reside as hardware tools external to local memory (606), or they may be implemented as a combination of hardware and software. Similarly, in one embodiment, the managers (660)-(666), may reside on a remote system in communication with the storage media (640). Accordingly, a manager may be implemented as a software tool or a hardware tool to support submission of one or more queries to an electronic patent document collection to yield a compilation of relevant patent documents.

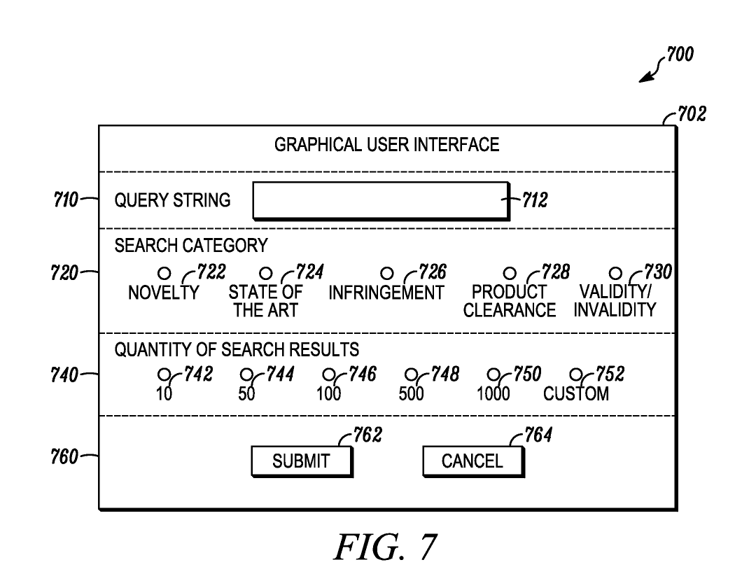

As described herein, a query may be submitted to the patent document collection with specific instructions pertaining to the static document vectors to be processed in the query execution. FIG. 7 is a block diagram (700) of a graphical user interface (702) that may be employed to support submission of instructions. The interface (702) functions as a veneer over instructions that support the underlying database of an electronic document collection. As shown, there are four primary fields. The first field (710) includes a field (712) for submission of a query to the document collection. The second field (720) includes multiple fields for selection of a search category. More specifically, as shown the second field (720) may include the following sub-fields for selection of the search category: novelty (722), state-of-the-art (724), infringement (726), product clearance (728), validity/invalidity (730). In one embodiment, the search field (720) may support selection of more than one sub-field. The third field (740) includes multiple fields for selection of the maximum quantity of search documents returned in a result compilation. More specifically, the third filed (740) may include the following sub-fields: ten documents (742), fifty document (744), one hundred documents (746), five hundred documents (748), one thousand documents (750), and an entry field (752) to support customized entry of the maximum quantity to be returned. The invention should not be limited to the sub-field amounts shown at (742)-(750). The numbers provided herein are merely exemplary. The fourth field (760) of the interface is employed for submission of the query string to the document collection. In one embodiment, the fourth field (760) includes a submit button (762) for entry of the query submission and a cancel button (764) to exit the submission. Accordingly, the interface shown herein facilitates communication and submission of a query to the electronic document collection to leverage the employment of one or more static document vectors therein.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public network.

The software implementation can take the form of a computer program product accessible from a computer-useable or computer-readable medium providing program code for use by or in connection with a computer or any instruction execution system.

### ADVANTAGES OVER THE PRIOR ART

Each patent document is known in the art to have a defined outline of sections that are required to meet statutory filing requirements. Multiple document vectors are created for each individual electronic document with the option to remove non-relevant patent strings from the document vectors. In one embodiment, one document vector is created for the claims section of document collection, another document vector is created for the title, abstract, and claims sections of the document collection, and a third document vector is created for all of the section of the document collection combined. Parsing of the vectors yields a smaller and more concise document vector, wherein a smaller document vector improves efficiency of query processing as the vector does not require the additional processing of the parsed strings. Not all queries are the same. Different queries are submitted to the collection to achieve different results. Accordingly, the categorization of the static document vectors, together with parsing of non-relevant patent terms enables a query submission to be efficiently and effectively processed to yield a desirable compilation of document results.

### ALTERNATIVE EMBODIMENTS

It will be appreciated that, although specific embodiments of the invention have been described herein for purposes of illustration, various modifications may be made without departing from the spirit and scope of the invention. In particular, searching of intellectual property documents is not limited to granted patents and published patent applications. Searching may be expanded to include all forms of intellectual property documents, including but not limited to trademark registrations and applications, copyright registrations and applications, and all forms of patent documents. Regardless of the document category for the query submission, there is a burden of resources for updating static document vectors in the document collection. Based upon the natural course of the progression of science, the document collection is a growing collection of documents, with new documents added to the collection on a weekly basis or at other times. The time interval set for updating the static document vectors may be a constant as intellectual property documents are granted and published at a set frequency. However, in one embodiment one or more variables may be employed to change the time interval. For example, in one embodiment, the time interval variable may change based upon the quantity of documents that are added to the collection in a defined period of time. The goal is to maintain an accurate document collection that may require periodic updating of the static document vectors in the collection to ensure a comprehensive data repository.

In addition, the electronic document collection has been specifically described pertaining to intellectual property documents. However, the invention should not be limited to these specific categories of electronic documents. In one embodiment, the electronic document collection may include any type of document that has a defined plurality of sections. This would enable the managers to parse the documents into the defined sections, create multiple static document vectors for each of the defined sections, and support defining a query based upon the defined sections of the documents. Accordingly, the scope of protection of this invention is limited only by the following claims and their equivalents.

What is claimed:

1. A computer implemented method for searching an electronic document collection comprising:
compiling a collection of intellectual property documents, each of the documents in the collection having at least one section;
at indexing time, deriving at least one document vector for each document in the collection based on said at least one sections, including creating at least one static document vector for each document in the document collection;
at query time, identifying a specific document vector based on a query input;
submitting said identified specific document vector to a search engine, and
a compilation of relevant documents returned based upon a comparison of said identified specific document vector to said at least one created static document vector.

2. The method of claim 1, wherein the step of identifying a specific document vector based on a query input further comprises creating a dynamic document vector based on string data from the query input.

3. The method of claim 1, further comprising creating a compilation of stop strings of intellectual property terms in a file and applying the compilation to the document vectors, including excluding each string in the compilation from each of the document vectors.

4. The method of claim 3, wherein said compilation of intellectual property terms is language specific.

5. The method of claim 3, wherein said compilation of intellectual property terms is culture specific.

6. The method of claim 3, further comprising dynamically updating the compilation of stop strings of intellectual property terms, including identifying specific terms for inclusion in the compilation.

7. The method of claim 1, further comprising limiting the static document vector to a selection of fields from an intellectual property document, said fields selected from the group consisting of: title, abstract, background, summary, detailed description, claims, drawings, and combination thereof.

8. The method of claim 7, further comprising creating a group of multiple static document vectors for each intellectual property document in the collection, each static document vector based upon one or more fields of the intellectual property document.

9. The method of claim 8, further comprising selecting a search scope for application to the document collection, wherein the search scope selection aligns with at least one static document vector category from the document collection, and comparing the selection of the at least one static vector category with the created dynamic vector based upon defined search scope.

10. The method of claim 9, wherein the search scope is an intellectual property infringement search, and further comprising selecting a claim vector category for the infringement search,
wherein the claim vector category selection limits the static document vector from the document collection to claims present in the underlying document collection.

11. The method of claim 9, wherein the search scope is an intellectual property infringement search invalidity search, and
further comprising selecting the claim title, abstract, summary, detailed description, claim, and
drawings vector categories for the invalidity search, wherein the selected vector categories selection limits the static document vector from the document collection to representative sections of intellectual property documents in the form of document vectors present in the underlying document collection.

12. The method of claim 9, wherein the search scope is a patent novelty search, and further comprising selecting the detailed description vector category for the novelty search,
wherein the detailed description vector category selection limits the static document vector from the document collection to detailed description sections of intellectual property documents in the form of document vectors present in the underlying document collection.

13. The method of claim 9, further comprising employing a graphical user interface layer for selecting the search scope.

14. The method of claim 1, further comprising setting a maximum limit for a quantity of relevant documents returned in the search.

15. The method of claim 1, wherein the compilation of relevant documents returned includes documents determined to have at least one static document vector within a defined mathematical range of the dynamic document vector.

16. A system comprising:
a processor in communication with storage media; the storage media to store an electronic document collection, the electronic document collection including a compilation of intellectual property documents, each of the intellectual property documents in the collection having multiple sections;
a document manager to derive, at indexing time, at least one document vector for each intellectual property document in the collection, including creation of at least one static document vector for each intellectual property document in the document collection;
an input manager to create, at query time, a dynamic document vector based on string data from a query input, said query input submitted to the electronic intellectual property document collection;
a query manager in communication with the input manager to compare said dynamic document vector with each static document vector in the collection in response to submission of the query input to the intellectual property document collection; and
a compilation of relevant intellectual property documents returned that are responsive to the query manager and based upon the comparison of the dynamic and static document vectors.

17. The system of claim 16, further comprising a compilation of non-relevant strings of intellectual property terms stored in a file, and the query manager to apply the compilation to the static document vectors, including excluding each string in the compilation from each of the document vectors.

18. The system of claim 17, wherein said compilation of intellectual property terms is
language specific.

19. The system of claim 17, wherein said compilation of intellectual property terms is
culture specific.

20. The system of claim 17, further comprising the document manager to dynamically update the compilation of non-relevant intellectual property terms, including identification of specific terms for inclusion in the compilation.

21. The system of claim 16, further comprising the document manager to limit the static document vector to a selection of fields from an intellectual property document, said fields selected from the group consisting of: title, background, abstract, summary, detailed description, claims, drawings, and combination thereof.

22. The system of claim 20, wherein the document manager creates multiple static document vectors for each intellectual property document in the collection, each static document vector based upon one or more fields of the intellectual property document.

23. The system of claim 22, further comprising a selection manager in communication with the query manager, the selection manager to select a search scope for application to the document collection, wherein the search scope selection aligns with at least one static document vector category from the document collection, and to compare the selection of the at least one static vector category with the created dynamic vector based upon defined search scope.

24. The system of claim 23, wherein the search scope is an infringement search, and
further comprising the selection manager to select the claim vector category for the infringement search, wherein the claim vector category selection limits the static document vector from the document collection to claims present in the underlying document collection.

25. The system of claim 23, wherein the search scope is an invalidity search, and further comprising the selection manager to select the claim title, abstract, summary, detailed description, claim, and drawings vector categories for the invalidity search, wherein the selected vector categories selection limits the static document vector from the document collection to representative sections of intellectual property documents in the form of document vectors present in the underlying document collection.

26. The system of claim 23, wherein the search scope is a novelty search, and
further comprising the selection manager to select the detailed description vector category for the novelty search, wherein the detailed description vector category selection limits the static document vector from the document collection to detailed description sections of intellectual property documents in the form of document vectors present in the underlying document collection.

27. The system of claim 23, further comprising a graphical user interface in communication with the query manager, the graphical user interface having an array of defined input selector to select the search scope for application to the document collection.

28. An article configured to search an electronic document collection on computer memory, the article comprising:
a computer-readable carrier including computer program instructions and to perform a query, the instructions comprising:
instructions to compile a collection of intellectual property documents, each of the intellectual property documents in the collection having multiple sections;
at indexing time, instructions to derive at least one document vector for each intellectual property document in the collection, including creation of at least one static document vector for each intellectual property document in the document collection;
at query time, instructions to create a dynamic document vector based on string data from a query input;
instructions to submit said query input to the electronic document collection, including comparison of the dynamic document vector with each static document vector in the collection; and
returning a compilation of relevant intellectual property documents based upon comparison of the dynamic and static document vectors.

29. The article of claim 27, further comprising instructions to create a compilation of non-relevant strings of intellectual property terms in a file and to apply the compilation to the document vectors, including excluding each string in the compilation from each of the document vectors.

30. The article of claim 29, wherein said compilation of intellectual property terms is language specific.

31. The article of claim 29, wherein said compilation of intellectual property terms is culture specific.

32. The article of claim 29, further comprising instructions to dynamically update the compilation of non-relevant intellectual property terms, including identifying specific terms for inclusion in the compilation.

33. The article of claim 28, further comprising instructions to limit the static document vector to a selection of fields from an intellectual property document, said fields selected from the group consisting of: title, abstract, background, summary, detailed description, claims, drawings and combination thereof.

34. The article of claim 33, further comprising instructions to create multiple static document vectors for each intellectual property document in the collection, each static document vector based upon one or more fields of the intellectual property document.

35. The article of claim 34, further comprising instructions to select a search scope for application to the document collection, wherein the search scope selection aligns with at least one static document vector category from the document collection, and to compare the selection of the at least one static vector category with the created dynamic vector based upon the defined search scope.

36. The article of claim 35, wherein the search scope is an infringement search, and
further comprising instructions to select the claim vector category for the infringement search, wherein the claim vector category selection limits the static document vector from the document collection to claims present in the underlying document collection.

37. The article of claim 35, wherein the search scope is an invalidity search, and
further comprising instructions to select the title, abstract, summary, detailed description, claim, and drawings vector categories for the invalidity search, wherein the selected vector categories selection limits the static document vector from the document collection to representative sections of intellectual property documents in the form of document vectors present in the underlying document collection.

38. The article of claim 35, wherein the search scope is a novelty search, and
further comprising instructions to select the detailed description vector category for the novelty search, wherein the detailed description vector category selection limits the static document vector from the document collection to detailed description sections of intellectual property documents in the form of document vectors present in the underlying document collection.

39. An article configured to search an electronic document collection on computer memory, the article comprising:
a computer-readable carrier including computer program instructions and to perform a query, the instructions comprising:
compiling means for compiling a collection of intellectual property documents, each of the intellectual property documents in the collection having multiple sections;
means for deriving at least one document vector, at indexing time, for each intellectual property document in the collection, including creation of at least one static document vector for each intellectual property document in the document collection;
means for creating a dynamic document vector, at query time, based on string data from a query input;
means for submitting said query input to the electronic document collection, including comparison of the dynamic document vector with each static document vector in the collection; and
means for returning a compilation of relevant intellectual property documents based upon comparison of the dynamic and static document vectors.
